(19) United States
(12) Patent Application Publication
(10) Pub. No.: US 2024/0200693 A1
(43) Pub. Date: Jun. 20, 2024

(54) PIPE CONSOLIDATION

(71) Applicant: Polyflow LLC, Midland, TX (US)

(72) Inventors: Malcolm Rosenow, Aiken, SC (US); Canyon Headrick, Humble, TX (US); Dillon Michael Hudson, Humble, TX (US); Chase Jonathan Hogan, The Woodlands, TX (US); Jose Fernando Sanchez, Houston, TX (US); Matthew Leonard Ryan, Spring, TX (US)

(21) Appl. No.: 18/069,102

(22) Filed: Dec. 20, 2022

(51) Int. Cl. F16L 11/08; B29C 63/34

(52) U.S. Cl. CPC F16L 11/081; B29C 63/34; B29C 2063/348

(57) ABSTRACT

A reinforced thermoplastic pipe (RTP), RTP body, and a method of providing RTP body are disclosed. The method of providing RTP body for storage and/or transportation of a fluid, comprises providing a first pipe body layer; providing a further pipe body layer coaxial with the first pipe body layer; providing a plurality of helically wound wire elements disposed between the first pipe body layer and the further pipe body layer; heating surrounding precursor thermoplastic material via Joule heating of the wire elements thereby providing viscous state thermoplastic polymer at least one of a first interface location between the first pipe body layer and the further pipe body layer; and subsequently cooling the viscous state thermoplastic polymer for joint consolidation thereby consolidating RTP body over at least a portion of a whole length of the RTP body.

### FIELD

Embodiments disclosed herein relate to multilayer reinforced thermoplastic pipe (RTP), and apparatus and a method for consolidating multi-layer RTP. For example and without limitation, embodiments disclosed herein relate to consolidating portions of multi-layer unbonded RTP by internally heating RTP body.

### BACKGROUND

Reinforced thermoplastic pipe (RTP) may either be of an unbonded construction, where the layers of the pipe are unbonded to each other, i.e. the inner fluid containing polymer liner layer is not bonded to the reinforcement layer, which is in turn not bonded to the outer protective sheath polymer layer, or of a bonded construction, i.e. all layers are bonded to each other as part of the pipe manufacturing resulting in a pipe which is in effect a single, consolidated layer comprising sub-layers. RTP of either type may be suitable for use in transporting and/or distributing oilfield fluids, such as water, gas (methane, ethane, CO₂ etc.) and/or the transport and distribution of hydrocarbon liquids, or other fluids such as hydrogen may be used onshore (over land) or in very shallow water applications (for instance less than 50 m water depth).

Structurally, multilayer RTP may have a simple construction, comprising two or more polymer layers each of which may be similar or different polymer types (see for example US2018/0187802A1). See also American Petroleum Institute Specification 15S as a reference for an example of these types of pipes. The inner and outer polymer layers (often termed a liner and protective sheath respectively) are extruded polymers of at least one type of polymer. Aptly for some applications the inner polymer layer may comprise sub-layers similar or different polymer compositions which are co-extruded to form a liner.

RTP body may be manufactured by progressively wrapping tape of a reinforcement layer over the previous layer, starting from the innermost layer progressively outwards to the outermost layer. The innermost layer of RTP body is often formed by extrusion. Parameters such as lay angle and the like may be varied according to any requirements of the layer being wound. This process of wrapping the layer around the previous layer may be referred to as a winding phase. The output of the winding phase is typically fed through an extruder to provide an outer protective sheath of polymer, the RTP body, can then be spooled and transported.

Conventionally, bonded RTP body is manufactured similarly to the manufacture of unbonded RTP body, with the addition that layers of RTP body are bonded or consolidated during the winding phase and/or during final sheath extrusion. For example, as reinforced tape is wound around the internal fluid retaining layer of RTP body, a heat source (typically hot air, or radiant heat from an infra-red source, or using a laser) is applied to soften the polymer in the reinforced tape, and/or the outer surface of the internal fluid retaining layer, to allow the reinforced tape to bond to the layer below. This process may be a vulcanisation or cross-linking process. This process of producing RTP pipe body is complex and limits the rate of production of bonded RTP body. Furthermore, it is not usually possible to consolidate unbonded RTP body at a later or separate stage to the initial manufacture of RTP body.

### SUMMARY

It is an aim of certain embodiments disclosed herein to at least partly mitigate one or more of the above-mentioned problems.

It is an aim of certain embodiments disclosed herein to separate the consolidation of RTP body from the manufacture of said unbonded RTP body.

It is an aim of certain embodiments disclosed herein to enable the consolidation of RTP body to be carried out in the field.

It is an aim of certain embodiments disclosed herein to heat RTP body by induction.

It is an aim of certain embodiments disclosed herein to provide apparatus for partially-consolidated RTP body.

It is an aim of certain embodiments disclosed herein to provide apparatus for partially-consolidated RTP body containing reinforcement wires and HDPE.

It is an aim of certain embodiments disclosed herein to provide apparatus for partially-consolidated RTP body containing reinforcement steel wires embedded in HDPE.

It is an aim of certain embodiments disclosed herein to provide apparatus for partially-consolidated RTP body containing reinforcement steel wires embedded in a polyethylene, a polypropylene, or a polyamide.

It is an aim of certain embodiments disclosed herein to provide apparatus for partially-consolidated RTP body containing reinforcement steel wires embedded in thermoplastic material that has a crystal structure associated with the heating and cooling of steel wires.

It is an aim of certain embodiments disclosed herein to provide apparatus for fully-consolidated RTP body.

It is an aim of certain embodiments disclosed herein to provide a method of directly heating electrically conductive elements.

It is an aim of certain embodiments disclosed herein to provide a method of directly heating electrically conductive elements within RTP body.

It is an aim of certain embodiments disclosed herein to provide a method of consolidating multi-layer RTP body.

It is an aim of certain embodiments disclosed herein to provide a method of consolidating multi-layer RTP body by Joule heating electrically conductive elements of RTP body.

It is an aim of certain embodiments disclosed herein to provide a method of consolidating multi-layer RTP body by induction heating electrically conductive elements of RTP body.

It is an aim of certain embodiments disclosed herein to provide a method of consolidating multi-layer RTP body by induction heating steel wires present in a thermoplastic reinforcement layer of RTP body.

According to a first aspect, there is provided a method of providing RTP body for storage and/or transportation of a fluid, comprising the steps of:
providing a first pipe body layer;
providing a further pipe body layer coaxial with the first pipe body layer;
providing a plurality of helically wound wire elements disposed between the first pipe body layer and the further pipe body layer;
heating surrounding precursor thermoplastic material via Joule heating of the wire elements thereby providing viscous state thermoplastic polymer at least one of a first interface location between the first pipe body layer and the further pipe body layer; and
subsequently cooling the viscous state thermoplastic polymer for joint consolidation thereby consolidating RTP body over at least a portion of a whole length of the RTP body.

In certain embodiments, said step of heating via Joule heating comprises, via an electromagnetic coil that comprises at least one turn, and optionally comprises a single turn coil or a multi turn coil, generating a magnetic field thereby inducing eddy currents in the ferromagnetic material wire elements thereby heating a surrounding volume via Joule heating.

In certain embodiments, the method further comprises applying pressure to a joint region where precursor thermoplastic material abuts with an adjacent layer until a viscous state thermoplastic polymer solidifies and optionally consolidating the RTP body over said a portion by bonding a first pipe body region associated with the first pipe body layer with a further pipe body region associated with the further pipe body layer.

In certain embodiments, the method further comprises during said step of heating the precursor thermoplastic material, determining a temperature of the thermoplastic material continuously or at least repeatedly via an infra-red camera directed at a surface proximate to an expected heating position and/or one or more thermocouples.

In certain embodiments, heating via Joule heating comprises, via an electromagnetic coil that comprises a single turn, urging the coil in an energised state from a start position proximate to a first end of the further pipe body layer towards a finish position a predetermined distance from the start position to thereby complete a traverse over a section of the further pipe body layer corresponding to said a position; and repeating the traverse a plurality of times and on each traverse de-energising the coil at least 3 centimetres before the respective finish position; and optionally applying an external consolidation force to the external surface of the RTP body, via rollers, to improve the movement and consolidation of viscous state thermoplastic polymer.

In certain embodiments, the method further comprises energising the coil with a power range of from 4 kW to 8 kW via a 15 kW water cooled induction unit at a frequency of from 60 kHz to 80 KHz.

In certain embodiments, the method further comprises energising the coil with a power range of 4 kW or approximately 4 kW to 8 kW or approximately 8 kW via a 15 kW or approximately 15 kW water cooled induction unit at a frequency of between 60 kHz or approximately 60 kHz and 80 kHz or approximately 80 KHz.

In certain embodiments, the method further comprises ensuring there is no dwell time at power as the coil is initially energised or de-energised.

In certain embodiments, heating via Joule heating comprises, via a multi turn electromagnetic coil, that optionally includes from 7 turns to 11 turns, selectively urging precursor pipe body comprising the first pipe body layer and the further pipe body layer through a cylindrical jig around which the coil is wrapped, in stages step-by-step and selectively energising the coil only with movement of the precursor pipe body paused and without overlapping a footprint of the coil on any region of precursor pipe body whilst heating; and optionally applying an external consolidation force to the external surface of the RTP body, via rollers, to improve the movement and consolidation of viscous state thermoplastic polymer.

In certain embodiments, the method further comprises applying from 5% to 15% of a total delivered power at from 2.8 kW to 3.5 kW.

In certain embodiments, the method further comprises applying between 5% and 15% of a total delivered power 2.8 kW or approximately 2.8 kW to 3.5 kW or approximately 3.5 kW.

In certain embodiments, the method further comprises energising the coil at a maximum frequency of from 28 kHz and to 35 kHz.

In certain embodiments, the method further comprises energising the coil at a maximum frequency of from 28 kHz or approximately 28 kHz to 35 kHz or approximately 35 kHz.

In certain embodiments, the method further comprises pausing movement of the precursor pipe body and energising the coil whilst in a paused state thereby heating a respective section of the precursor pipe body for from 95 seconds to 115 seconds.

In certain embodiments, the method further comprises pausing movement of the precursor pipe body and energising the coil whilst in a paused state thereby heating a respective section of the precursor pipe body for from 95 or approximately 95 seconds to 115 or approximately 115 seconds.

In certain embodiments, the method further comprises Joule heating from 70 centimetres to 90 centimetres in length of a total length of the precursor pipe body.

In certain embodiments, the method further comprises Joule heating from 70 or approximately 70 centimetres to 90 or approximately 90 centimetres in length of a total length of the precursor pipe body.

According to a second aspect, there is provided RTP body for storage and/or transportation of a fluid, comprising:
a first pipe body region;
a further pipe body region coaxial with the first pipe body region; and
a plurality of wire elements that extend helically along at least a portion of a whole length of the first pipe body region and that are embedded, along said a portion, in thermoplastic material that has a crystal structure associated with a cooling temperature gradient that is cooler at a radially outer region than at a radially inner region relative to a central bore axis; wherein
the RTP body comprising the first and further pipe body region is consolidated along said a portion.

In certain embodiments, the crystal structure is a crystal structure associated with a rate of cooling associated with convection cooling from a metal-thermoplastic interface.

In certain embodiments, the thermoplastic material is a polyethylene or a polypropylene or a polyamide and the consolidated region has a from 60% to 90% crystallinity and optionally the consolidated region has an amorphous volume of from 10% to 40% of amorphous material.

In certain embodiments, the thermoplastic material is a polyethylene or a polypropylene or a polyamide and the consolidated region has a 60% or approximately 60% to 90% or approximately 90% crystallinity and optionally the consolidated region has an amorphous volume of from 10% or approximately 10% to 40% or approximately 40% of amorphous material.

In certain embodiments, the first pipe body region comprises a one of a fluid retaining pipe region or an outer sheath pipe region and the further pipe body region comprises a thermoplastic pipe region or a remainder one of the fluid retaining pipe region and the outer sheath region.

According to a third aspect, there is provided an RTP for storage and/or transportation of a fluid, comprising:
a first end fitting that terminates a first end of a segment of RTP body and a further end fitting that terminates a remaining end of the RTP body; wherein
the RTP body comprises a thermoplastic pipe region that comprises a plurality of embedded wire elements that extend helically within the thermoplastic pipe region over a portion of the RTP body that extends from the first end fitting where the RTP body is consolidated or that extends over a portion of the RTP body between the first end fitting and the further end fitting where the RTP body is consolidated.

In certain embodiments, said a portion comprises a length of from 0.5 m to 2.0 m from the first end fitting and the wire elements and thermoplastic pipe region terminate at an end position of said a length.

In certain embodiments, said a portion of the RTP body that extends from the first end fitting where the RTP body is consolidated or that extends over a portion of the RTP body between the first end fitting and the further end fitting where the RTP body is consolidated has a length of 0.5 m or approximately 0.5 m to 2.0 m or approximately 2.0 m from the first end fitting and the wire elements and thermoplastic pipe region terminate at an end position of said length.

In certain embodiments, said a portion comprises a whole length of the RTP body between the first and further end fittings and the thermoplastic pipe region and associated embedded wire elements extend along the whole length.

In certain embodiments, the wire elements each comprise a single strand metal wire or single strand metal alloy wire or a multi strand metal wire or a multi strand metal alloy wire and optionally a first plurality of the wires are disposed a respective first radial distance from a main central axis associated with the RTP and a further plurality of wires are disposed a respective further radial distance, that is greater than the first radial distance from the main central axis.

According to a fourth aspect, there is provided RTP body for storage and/or transportation of a fluid, comprising:
a fluid retaining pipe region;
an outer sheath pipe region coaxial with the fluid retaining pipe region; and
a thermoplastic pipe region between and coaxial with the fluid retaining pipe region and the outer sheath pipe region; wherein
the thermoplastic pipe region comprises a plurality of ferromagnetic wire elements that extend helically within the thermoplastic pipe region, the thermoplastic pipe region further comprising a precursor thermoplastic material, said ferromagnetic wire elements being embedded in the thermoplastic pipe region; wherein
at at least a portion of the RTP body a first intermediate pipe region, between a radially outer zone of the outer sheath pipe region that comprises only outer sheath material and a central zone of the thermoplastic pipe region, that comprises fused outer sheath material and precursor thermoplastic material.

According to a fifth aspect, there is provided RTP body for storage and/or transportation of a fluid, comprising:
a fluid retaining pipe region;
an outer sheath pipe region coaxial with the fluid retaining pipe region; and
a thermoplastic pipe region between and coaxial with the fluid retaining pipe region and the outer sheath pipe region; wherein
the thermoplastic pipe region comprises a plurality of ferromagnetic wire elements that extend helically within the thermoplastic pipe region, the thermoplastic pipe region further comprising a precursor thermoplastic material, said ferromagnetic wire elements being embedded in the thermoplastic pipe region; wherein
at at least a portion of the RTP body a further intermediate pipe region, between the central zone of the thermoplastic pipe region and a radially inner zone of the fluid retaining pipe region that comprises only fluid retaining layer material, that comprises fused fluid retaining layer material and precursor thermoplastic material.

According to a sixth aspect, there is provided RTP body for storage and/or transportation of a fluid, comprising:
a fluid retaining pipe region;
an outer sheath pipe region coaxial with the fluid retaining pipe region; and
a thermoplastic pipe region between and coaxial with the fluid retaining pipe region and the outer sheath pipe region; wherein
the thermoplastic pipe region comprises a plurality of ferromagnetic wire elements that extend helically within the thermoplastic pipe region, the thermoplastic pipe region further comprising a precursor thermoplastic material, said ferromagnetic wire elements being embedded in the thermoplastic pipe region; wherein
at at least a portion of the RTP body a first intermediate pipe region, between a radially outer zone of the outer sheath pipe region that comprises only outer sheath material and a central zone of the thermoplastic pipe region, that comprises fused outer sheath material and precursor thermoplastic material; and wherein
at the said portion of the RTP body a further intermediate pipe region, between the central zone of the thermoplastic pipe region and a radially inner zone of the fluid retaining pipe region that comprises only fluid retaining layer material, that comprises fused fluid retaining layer material and precursor thermoplastic material.

In certain embodiments, the ferromagnetic material is a metal or metal alloy, and optionally is stainless steel, and each wire element is a single strand or multi strand elongate wire.

According to a seventh aspect, there is provided RTP body for storage and/or transportation of a fluid, comprising:
a fluid retaining pipe region;
an outer sheath pipe region coaxial with the fluid retaining pipe region; and
a thermoplastic pipe region between and coaxial with the fluid retaining pipe region, the fluid retaining pipe region and outer sheath pipe region each being consolidated with the thermoplastic pipe region along at least a portion of a whole length of the fluid retaining pipe region; wherein
the thermoplastic pipe region comprises a plurality of ferromagnetic wire elements that extend helically within the thermoplastic pipe region over said a portion and are embedded in the thermoplastic pipe region.

In certain embodiments, the RTP body further comprises a first intermediate pipe region, between a radially outer zone of the outer sheath pipe region that comprises only outer sheath material and a central zone of the thermoplastic pipe region, that comprises fused outer sheath material and precursor thermoplastic material.

In certain embodiments, the RTP body further comprises a further intermediate pipe region, between the central zone of the thermoplastic pipe region and a radially inner zone of the fluid retaining pipe region that comprises only fluid retaining layer material, that comprises fused fluid retaining layer material and precursor thermoplastic material.

In certain embodiments, the ferromagnetic material is a metal or metal alloy, and optionally is stainless steel, and each wire element is a single strand or multi strand elongate wire.

According to an eighth aspect, there is provided a method of providing RTP body for storage and/or transportation of a fluid, comprising the steps of:
providing a fluid retaining layer;
providing a tape layer by helically winding a thermoplastic tape, that comprises ferromagnetic material wire elements embedded in precursor thermoplastic material, around at least a portion of the fluid retaining layer;
providing an outer sheath layer over the tape layer;
   heating the precursor thermoplastic material of the thermoplastic tape via induction heating, thereby heating polymer material of the outer sheath layer and/or fluid retaining polymer material from the fluid retaining layer, thereby providing viscous state thermoplastic polymer at at least one of a first interface location between the fluid retaining layer and tape layer and a further interface location between the tape layer and the outer sheath; and
cooling the viscous state thermoplastic polymer for joint consolidation thereby consolidating at least one of a fluid retaining pipe region and an outer sheath pipe region with a thermoplastic pipe region.

According to a ninth aspect, there is provided a method of providing flexible pipe body for storage and/or transportation of a fluid, comprising the steps of:
providing a first pipe body layer;
providing a further pipe body layer coaxial with the first pipe body layer;
providing a plurality of helically wound wire elements disposed between the first pipe body layer and the further pipe body layer;
heating surrounding precursor thermoplastic material via Joule heating of the wire elements thereby providing viscous state thermoplastic polymer at least one of a first interface location between the first pipe body layer and the further pipe body layer; and
subsequently cooling the viscous state thermoplastic polymer for joint consolidation thereby consolidating flexible pipe body over at least a portion of a whole length of the flexible pipe body.

According to a tenth aspect, there is provided flexible pipe body for storage and/or transportation of a fluid, comprising:
a first pipe body region;
a further pipe body region coaxial with the first pipe body region; and
a plurality of wire elements that extend helically along at least a portion of a whole length of the first pipe body region and that are embedded, along said a portion, in thermoplastic material that has a crystal structure associated with a cooling temperature gradient that is cooler at a radially outer region than at a radially inner region relative to a central bore axis; wherein
flexible pipe body comprising the first and further pipe body region is consolidated along said a portion.

According to an eleventh aspect, there is provided flexible pipe for storage and/or transportation of a fluid, comprising:
a first end fitting that terminates a first end of a segment of flexible pipe body and a further end fitting that terminates a remaining end of the flexible pipe body; wherein
the flexible pipe body comprises a thermoplastic pipe region that comprises a plurality of embedded wire elements that extend helically within the thermoplastic pipe region over a portion of the flexible pipe body that extends from the first end fitting where the flexible pipe body is consolidated or that extends over a portion of the flexible pipe body between the first end fitting and the further end fitting where the flexible pipe body is consolidated.

Certain embodiments provide apparatus that includes partially-consolidated RTP body.

Certain embodiments provide apparatus that includes fully-consolidated RTP body.

Certain embodiments provide apparatus that includes partially-consolidated RTP body with steel wires embedded in a thermoplastic material.

Certain embodiments provide apparatus that includes partially-consolidated RTP body with steel wires embedded in HDPE.

Certain embodiments provide apparatus that includes partially-consolidated RTP body with steel wires embedded in a polyethylene, a polypropylene, or a polyamide.

Certain embodiments provide a method for consolidating RTP body.

Certain embodiments provide a method for consolidating a portion of RTP body by Joule heating components of said RTP body.

Certain embodiments provide a method for consolidating a portion of RTP body by induction heating reinforcement wires of said RTP body.

Certain embodiments provide a method for consolidating a portion of RTP body by induction heating steel wires of said RTP body.

### BRIEF DESCRIPTION OF THE DRAWINGS

Some embodiments of the present disclosure will now be described hereinafter, by way of example only, with reference to the accompanying drawings in which:

FIG. 1 illustrates RTP body;

FIG. 2 illustrates certain uses of RTP;

FIG. 3 illustrates a cross-section of RTP body;

FIG. 4 illustrates tape made of polyethylene and steel wire;

FIG. 5 illustrates an axial section of RTP body pre-consolidation;

FIG. 6 illustrates an axial section of consolidated RTP body;

FIG. 7 illustrates partially-consolidated RTP body and an end fitting;

FIG. 8 illustrates a method of manufacturing bonded RTP body; and

FIG. 9 illustrates another method of manufacturing bonded RTP body.

FIG. 10 illustrates an axial section of alternative RTP body pre-consolidation;

FIG. 11 illustrates an axial section of alternative RTP body pre-consolidation;

FIG. 12 illustrates different partially-consolidated RTP body and an end fitting; and

FIG. 13 illustrates fully-consolidated RTP body and an end fitting.

In the drawings like reference numerals refer to like parts.

### DETAILED DESCRIPTION

Throughout this description, reference will be made to a type of flexible pipe known as reinforced thermoplastic pipe (RTP). It is to be appreciated that certain embodiments may also be applicable to use with a wide variety of flexible pipe. For example, certain embodiments can also be used with respect to flexible pipe body and associated end fittings of the type which is manufactured according to API 17J. Such flexible pipe is often referred to as unbonded flexible pipe.

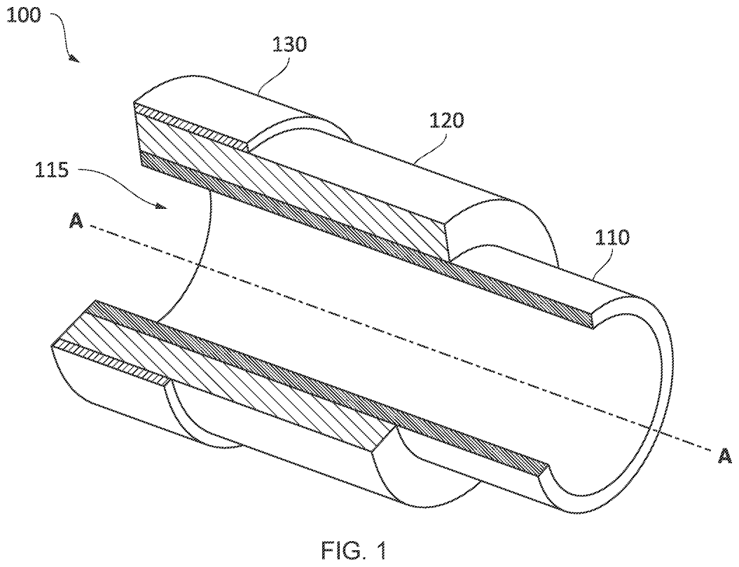

It will be understood that the illustrated RTPs are an assembly of a portion of RTP body and one or more end fittings (not shown) in each of which a respective end of RTP body is terminated. FIG. 1 illustrates how pipe body 100 is formed from a combination of layered materials that form a pressure-containing conduit according to a first embodiment. RTP body 100 has a central axis marked by A-A in FIG. 1. As noted above, although a number of particular layers are illustrated in FIG. 1, it is to be understood that certain embodiments are broadly applicable to coaxial pipe body structures including two or more layers manufactured from a variety of possible materials. Pipe body 100 may include one or more layers comprising composite materials, forming a tubular composite layer. It is to be further noted that the layer thicknesses are shown for illustrative purposes only. As used herein, the term “composite” is used to broadly refer to a material that is formed from two or more different materials, for example a material formed from a matrix material and reinforcement fibres. Pipe body may include one or more layers of a single material, forming a tubular uniform layer.

A tubular composite layer is thus a layer having a generally tubular shape formed of composite material. Alternatively, a tubular composite layer is a layer having a generally tubular shape formed from multiple components one or more of which is formed of a composite material. The layer or any element of the composite layer may be manufactured via an extrusion, pultrusion or deposition process or, by a winding process in which adjacent windings of tape which themselves have a composite structure are bonded together with adjacent windings. The bonded composite layers are thus consolidated. The composite material, regardless of manufacturing technique used, may optionally include a matrix or body of material having a first characteristic in which further elements having different physical characteristics are embedded. That is to say elongate fibres which are aligned to some extent and/or smaller fibres randomly orientated can be set into a main body, or spheres or other regular or irregular shaped particles can be embedded in a matrix material, or a combination of more than one of the above. In certain embodiments, the matrix material is a thermoplastic material. In certain embodiments, the thermoplastic material is polyethylene or polypropylene or nylon or PPS or PVC or PVDF or PFA or PEEK or PTFE, alloys of such materials, or alloys of such materials with reinforcing fibres manufactured from one or more of ceramic, carbon, carbon nanotubes, aramid, steel, nickel alloy, titanium alloy, aluminium alloy or the like or fillers manufactured from ceramic, carbon, metals, buckminsterfullerenes, metal silicates, carbides, carbonates, oxides or the like.

The RTP body 100 illustrated in FIG. 1 includes a fluid retaining layer 110 which is non-porous. In certain embodiments, the fluid retaining layer 110 is tubular in shape. The fluid retaining layer 110 is a polymer layer that ensures internal fluid integrity. The layer can provide a boundary for any conveyed fluid. It is to be understood that the fluid retaining layer 110 may itself comprise a number of sub-layers in some embodiments.

The fluid retaining layer 110 is made of high-density polyethylene (HDPE). It will be appreciated that in other embodiments, the fluid retaining layer 110 may be made of a different polymer. It will be appreciated that in some embodiments, the fluid retaining layer 110 may be made of any polyethylene, a polypropylene, or a polyamide. The fluid retaining layer 110 in FIG. 1 is formed by an extrusion process, although it will be appreciated by a person skilled in the art that the fluid retaining layer may be manufactured in other ways. The fluid retaining layer 110 is the innermost layer of RTP body 100 and thus defines a pipe bore 115 of RTP body. Aptly, the internal diameter of the fluid retaining layer—which may also be referred to as the bore 115—is 6 inches (152.4 mm). It will be appreciated that in other embodiments the pipe bore 115 may be larger or smaller in diameter. In certain embodiments, the bore fluid is constrained to being within the bore 115 of RTP body 100.

The embodiment of RTP body as shown in FIG. 1 includes a thermoplastic reinforcement layer 120. The thermoplastic reinforcement layer may also be referred to as a reinforcement layer. The reinforcement layer 120 provides structural support to RTP body 100. In other words the reinforcement layer 120 may help to improve the resistance of RTP body to internal or external pressures, tensile forces, torsion, or the like. The reinforcement layer 120 is coaxial and radially external to the fluid retaining layer 110. As shown in FIG. 1, the reinforcement layer 120 is in physical contact with the fluid retaining layer 110. It will be appreciated that in some embodiments, the reinforcement layer 120 may be composed of a plurality of layers.

The reinforcement layer 120 is formed of pairs of tapes cross-wound around the fluid retaining layer 110 with a lay angle of around +/−55° (not shown). In other words, each pair of tapes is wound helically in clockwise and counterclockwise directions respectively. It will be appreciated that, in other embodiments, the lay angle may be between 10° and 90°. It will be appreciated that the lay angle may be chosen depending on the reinforcement requirements of the reinforcement layer 120. For example, a shallower lay angle may provide greater resistance to axial forces along RTP body. The tapes are made of HDPE reinforced with fibres of steel. It will be appreciated that in other embodiments, the steel fibre may be exchanged for an alternative electrically conductive metal, polymer, carbon, ceramic, or the like, or a mixture of electrically conductive fibres and non-conductive reinforcement fibres where the electrically conductive fibres provide little or no structural reinforcement to the pipe body and purely act to facilitate consolidation of pipe layers. It will be appreciated that the steel fibre may itself be composed of multiple fibres threaded or otherwise bunched together. It will be appreciated that in other embodiments, the HDPE may be replaced by another polymer such as any polyethylene, a polypropylene, or a polyamide, or the like.

It will also be appreciated that in some embodiments, the reinforcement layer 120 may comprise conductive fibres or strands or bunches of fibres which may be applied to the pipe without being incorporated into a tape (i.e. without a polymer matrix around the fibres).

RTP body also includes an outer sheath 130, which comprises a polymer layer used to protect the pipe against penetration of seawater and other external environments, corrosion, abrasion and mechanical damage. The outer sheath 130 is coaxial to the reinforcement layer 120 and the fluid retaining layer 110. As shown in FIG. 1, the outer sheath 130 is in physical contact with the reinforcement layer 120. The outer sheath is the outermost layer of RTP body 100. The outer sheath 130 is made of HDPE. The outer sheath 130 is tubular in shape and is manufactured using an extrusion process. It will be appreciated that in other embodiments, the outer sheath may be formed from any polyethylene, a polypropylene, or a polyamide. It will be appreciated that in other embodiments, a manufacturing process such as tape winding or the like may be used to make the outer sheath. Whilst the embodiment shown in FIG. 1 has three layers: the fluid retaining layer 110, the thermoplastic layer 120, and the outer sheath 130; it will be appreciated that in some embodiments described herein, RTP body may have the fluid retaining layer 110, a plurality of helically wound steel wires, and the outer sheath 130. In some embodiments, the plurality of steel wires (not shown) may be located radially between the fluid retaining layer 110 and the outer sheath 130.

The pipe bore 115 of RTP body 100 is hollow. Bore fluid is able to flow in a direction broadly parallel with the central axis A-A of RTP body 100. It will be appreciated that RTP body 100 may be deformed by external or internal forces without breaking. External forces may deform RTP body 100 and determine a shape adopted by the RTP.

Each RTP comprises at least one portion, referred to as a segment or section, of pipe body 100 together with an end fitting located at at least one end of the RTP. The end fitting provides a mechanical device which forms the transition between RTP body and a connector. The different pipe layers as shown, for example, in FIG. 1 are terminated in the end fitting in such a way as to transfer the load between RTP body and the connector.

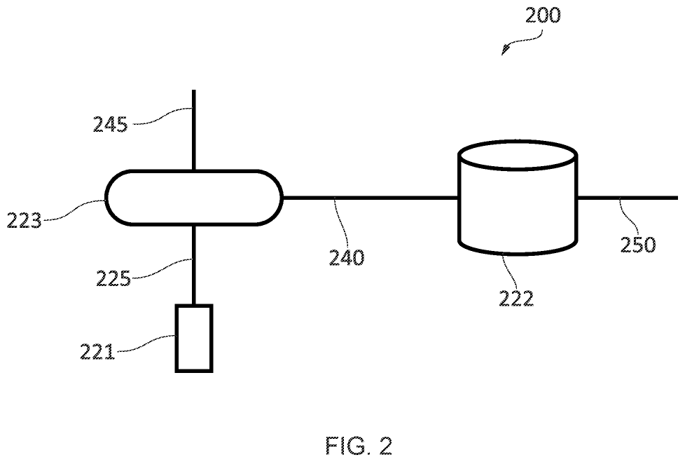

FIG. 2 illustrates an onshore assembly 200 suitable for transporting production fluid such as oil and/or gas and/or water from a wellhead production tree 221 to a storage facility 222 via a three-phase separator 223. For example, in FIG. 2, the production tree 221 includes a wellhead flow line 225. The flexible flow line 225 includes an RTP, wholly or in part, resting on the ground or buried in a trench and used in a static application. The onshore assembly 200 is provided as a spoolable pipe, that is to say an RTP 240 connecting the three-phase separator 223 to the storage facility 222. RTP may be in segments of RTP body with connecting end fittings.

The onshore assembly 200 in FIG. 2 illustrates how portions of the RTP can be utilised as a gas export pipe 245 or an oil export pipe 250. The portions of the RTP in the onshore assembly 200 can have different pipe diameters, can withstand different pressures, and can have other specification differences according to their use. Some, though not all, examples of such configurations can be found in API 15S. It will be appreciated that in other embodiments, the RTP, RTP body and the end fittings may be used for different purposes such as water disposal pipes, gas injection pipes, produced gas pipes, CO2 export pipes, and the like.

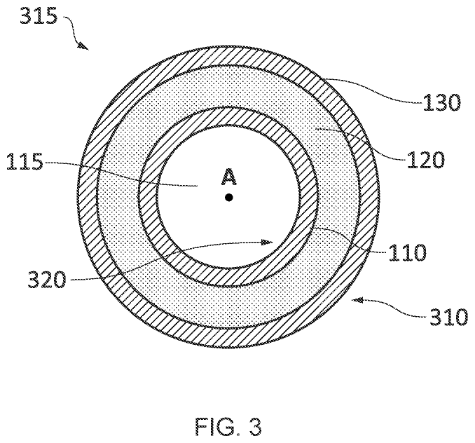

FIG. 3 illustrates a cross-section of RTP body 100. The central axis A-A is oriented in FIG. 3 such that A-A extends in a direction perpendicular to the cross-section. The layers shown in FIG. 1 are visible, including the innermost fluid retaining layer 110, the reinforcement layer 120, and the outer sheath 130. It will be appreciated that in other embodiments, any layer of RTP body may be composed of a plurality of layers.

As shown in FIG. 3, the reinforcement layer 120 is coaxial with the fluid retaining layer 110. Likewise, the outer sheath 130 is coaxial with the fluid retaining layer 110. The internal diameter of the reinforcement layer 120 is greater than the internal diameter of the fluid retaining layer 110. The internal diameter of the outer sheath 130 is greater than the internal diameter of the reinforcement layer 120 or the internal diameter of the fluid retaining layer 110.

In FIG. 3, an outer surface 310 of RTP body 100 is visible. The outer surface 310 is exposed to an external environment 315. The environment 315 may be an offshore or onshore environment. An inner surface 320 of RTP body 100 is also visible. The inner surface 320 defines the pipe bore 115. The pipe bore 115 in FIG. 3 is 6 inches (152.4 mm). It will be appreciated that in other embodiments, the pipe bore 115 may be larger or smaller than 6 inches (152.4 mm). The inner surface 320 is often in contact with the bore fluid. The bore fluid may be a liquid or a gas or a combination of liquid and gas.

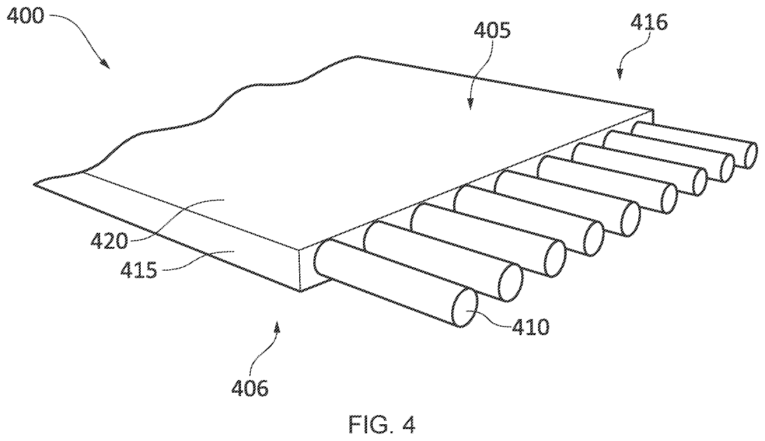

FIG. 4 illustrates tape 400 made of high density polyethylene (HDPE), sometimes referred to as a polymer matrix, and steel wire, also sometimes referred to as steel wire tape or reinforced tape. The tape 400 may be used to form the thermoplastic reinforcement layer in FIGS. 1 and 3. It will be appreciated that in other embodiments, a thermoplastic other than HDPE may be used. It will be appreciated that in other embodiments the thermoplastic may be another type of polymer. It will also be appreciated that in other embodiments, the steel wires may be any electrically conductive material. It will be appreciated that in other embodiments, the steel wires may be any ferromagnetic material. In some embodiments, the steel wires may be any magnetically permeable material. In other embodiments the electrically conductive material may only comprise a proportion of the reinforcements of the tape, for instance 10% of the fibres may comprise an electrically conductive material and the remaining reinforcements comprise a non-conductive material, the conductive material primarily to promote the generation of heat in the polymer matrix, and the remaining reinforcements to provide structural strength to the RTP body. In some embodiments the electrically conductive material may be dispersed through the thermoplastic tape material or be mainly provided around the peripheral surfaces of the tape for instance in a form of cage or net. In certain embodiments, the electrically conductive material may be wires which act as weft wires interleaving and interwoven in and out of warp (longitudinally aligned) reinforcements of non-electrically conducting reinforcement fibres or strands, the tape optionally with or without the addition of a thermoplastic polymer matrix. In some embodiments, a tape including a combination of electrically conductive fibres, non-conductive reinforcement fibres and thermoplastic polymer fibres may be applied as the reinforcement tape, the heat generated through joule or induction heating melting the thermoplastic polymer fibres to provide a bond between the reinforcement layers and/or adjacent pipe layers.

The tape 400 is used to form the reinforcement layer of RTP body. The tape 400 is wound along a length of RTP body 100 wherein the lay angle is 55°. The tape may provide helical reinforcement. It will be appreciated that in other embodiments, the lay angle of the tape 400 may be different. Referring to FIG. 4, the tape 400 has a top surface 405 and a bottom surface 406. Accordingly, when the tape 400 is wound along the length of RTP body 100, the bottom surface 406 of tape may contact an underlying layer of RTP body. The bottom surface 406 of tape may also contact the top surface 405 of tape at some points when there is overlap of the tape. It will be appreciated by a person skilled in the art that the tape 400 thickness is defined from top surface 405 to bottom surface 406. It will also be appreciated that the tape 400 width is defined from a first tape side 415 to a further tape side 416. It will be appreciated that in some embodiments, the width and thickness of tape 400 may be defined differently.

The tape shown in FIG. 4 is broadly a flat strip with thickness that is very much smaller than the width which very much smaller than a length dimension. In certain embodiments the ratio of width to thickness is 8 to 1 or less. In certain embodiments, the ratio is 12 to 1 or less. In some embodiments, the tape 400 has a cross-section which provides for interlocking or overlapping. In other words, in some embodiments, neighbouring layers of tape 400 may have a cross-section such that features in the top surface 405 may align with features in the bottom surface 406.

The tape 400 is made of nine steel wires 410. In some embodiments, the steel wires 410 may be steel cords, wherein the steel cords are made of a number of twisted strands of steel fibres. The steel wires 410 are arranged side-by-side in one direction to form an elongate shape with a negligible thickness compared to length and width. In other words, the steel wires 410 in the tape 400 are arranged parallel to one another such that in the dimension of thickness of the tape 400 there is only one steel wire 410. In some embodiments, the steel wires 410 are arranged such that in the dimension of thickness of the tape 400 there is more than one steel wire 410. In some embodiments, the steel wires may have a different diameter. In some embodiments, the steel wires may have a different separation distance or be separated at different distances from each other. In some embodiments, there may be a different number of steel wires.

The tape 400 also includes an HDPE matrix 420. It will be appreciated that in some embodiments, the HDPE matrix 420 may be a polyethylene, a polypropylene, or a polyamide matrix. The HDPE matrix 420 surrounds the steel wires 410, holding the tape 400 together. In other words, the steel wires 410 are embedded in a matrix of HDPE 420. Consequently, in some embodiments, the shape of the HDPE 420 defines the outer dimensions of the tape 400. In some embodiments, the HDPE 420 is bonded to the steel wires 410 through a prior heating process, for instance extrusion or pultrusion. It will be appreciated that in other embodiments, the steel wires 410 may not be bonded to the HDPE 420, whereby an adhesive, friction, the addition of transverse weft element fibres woven around the wires, or the like may be used to hold the tape 400 structure together.

When the tape 400 is used to form layers in RTP body, the layer may be heated such that the HDPE matrix 420 is melted. Thus, the layer bonds to neighbouring layers in RTP body forming a so-called bonded RTP body. It will be understood that when neighbouring layers of tape 400 are bonded together the neighbouring layers are consolidated.

The tape 400 may be heated by induction. In an induction heating process, the steel wires 410 of the tape 400 are exposed to a changing magnetic field. The changing magnetic field induces eddy currents in the electrically conductive steel wires 410. The eddy currents heat the steel wires 410 by Joule heating. Due to the heating of the steel wires 410, the surrounding HDPE 420 is heated to its melting point. At this stage the tape 400 layer bonds to adjacent layers in the RTP body. In another embodiment, the electrically conductive steel wires 410 are heated by another form of Joule heating in which an electrical current is directly applied along the steel wires 410. It will be appreciated that Joule heating is resistive heating. Optionally rollers may be applied to the external surface of the RTP body just after the induction heating process in order to apply pressure to the viscous state thermoplastic polymer of the reinforcement material and/or the inner or outer sheaths to improve consolidation and bonding.

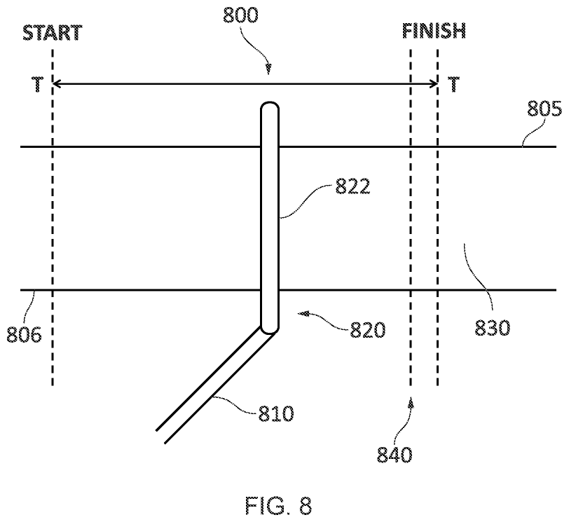

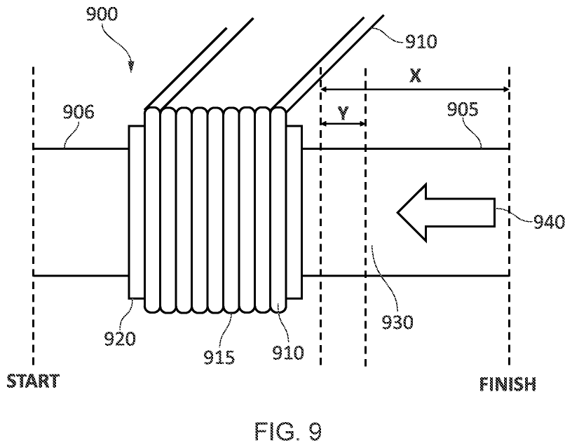

The changing magnetic field includes a first parameter of frequency. The first parameter may be controlled and measured by an oscillator. The changing magnetic field includes a second parameter of power level (kilo-watts). The second parameter may be controlled and measured by an electrical power drawn by the induction heating process. Methods of induction heating are shown in more detail in FIGS. 8 and 9.

During the heating process a temperature measurement of any combination of HDPE 420 and steel wires 410 may be recorded using thermocouples. It will be appreciated that the temperature measurements may be used to control at least the first and further parameters of the changing magnetic field.

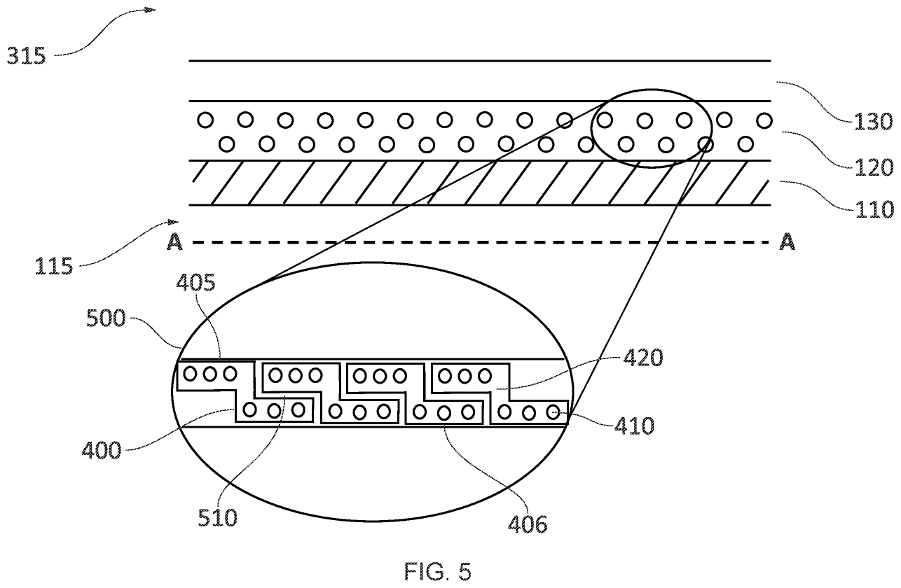

FIG. 5 illustrates an axial section of RTP body pre-consolidation. The central axis A-A of RTP body is shown in a horizontal orientation. The multi-layer structure of RTP body is visible such that the pipe bore is nearest the bottom of FIG. 5 and the external environment 315 is nearest the top. RTP body shown in FIG. 5 has three layers, although it will be appreciated that in another embodiment, RTP body may have two layers, or four layers, or any other number of layers.

In the embodiment shown in FIG. 5, there is a detailed section 500 that shows the structure of RTP body in more detail. FIG. 5 includes the fluid retaining layer 110, the reinforcement layer 120, and the outer sheath 130. The fluid retaining layer 110 is the innermost layer of RTP body. The fluid retaining layer 110 is non-porous and made using an extrusion process from HDPE. It will be appreciated that in other embodiments, the fluid retaining layer 110 may be made from another polymer. It will be appreciated that in other embodiments another manufacturing process may be used to form the fluid retaining layer 110.

The reinforcement layer 120 is located between the fluid retaining layer 110 and the outer sheath 130. The reinforcement layer 120 is composed of one pair of tapes 400 that are wound helically around the layer below. The tapes 400 in the reinforcement layer are frequently wound in pairs. In other words, in the reinforcement layer 120 there is a first tape wound in a clockwise direction and a further tape wound over the first tape in a counter-clockwise direction. The lay angle of the helically wound tapes is +/−55°. Consequently, there may be areas of overlap 510 where the top surface 405 of tape 400 is in contact with the bottom surface 406 of tape 400; this is a consequence of the tape and pipe geometries. In some embodiments with different tape and pipe geometries, the tape, wound at the lay angle, will not overlap the previous wrap of tape and instead abut the previous wrap, tape edge to tape edge. It will be appreciated that in other embodiments a different lay angle may be used when winding tape 400 in the reinforcement layer. It will be appreciated that in other embodiments a different number of pairs of tape 400 may be used in the reinforcement layer. The tapes 400 are made from steel wires 410 surrounded by an HDPE matrix 420. In some embodiments the steel wires 410 may be bonded to the HDPE 420. The tapes 400 may be the tapes in FIG. 4. It will be appreciated that in other embodiments, another polymer may be used instead of HDPE 420. It will be appreciated that in other embodiments, the steel may be replaced by another electrically conductive material.

The outer sheath 130 forms the outermost layer of RTP body. The outer sheath is in contact with the external environment 315. The external environment 315 may be offshore or onshore. In some embodiments, the external environment 315 may be submerged in water, on dry land—above or underground, or the like. The external environment 315 may involve high pressures, high temperatures, low temperatures, corrosive chemicals, or the like. The outer sheath 130 is made from HDPE that is extruded into a tubular shape. In other embodiments, the outer sheath 130 may be made using a different manufacturing process. In other embodiments, the outer sheath 130 may be made from a different polymer. In some embodiments, the fluid retaining layer 110 may be a first pipe body layer.

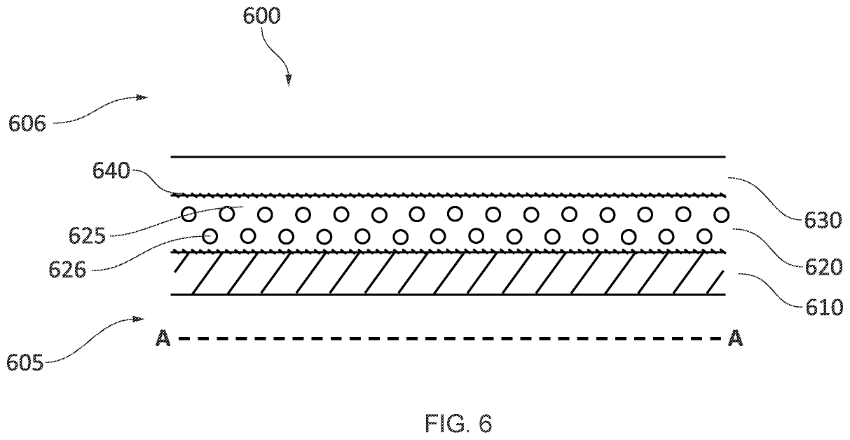

FIG. 6 illustrates an axial section of consolidated RTP body 600. Consolidated RTP body 600 may be referred to as bonded RTP body. Consolidated RTP body 600 may be formed from the unbonded RTP body shown in FIG. 5. The central axis A-A of RTP body is shown with horizontal orientation at the bottom of FIG. 6. Consequently, the bore region 605 of RTP body is at the bottom of the multi-layer structure shown in FIG. 6. The bore region 605 may correspond to the pipe bore 115 of unbonded RTP body. On the other side of the multi-layer structure there is an outside environment 606 relative to RTP body. The outside environment may include an offshore or onshore environment.

Consolidated RTP body 600 has a fluid retaining region 610. The fluid retaining region 610 is made from HDPE that is extruded into tubular form. The fluid retaining region 610 is non-porous, enclosing bore fluid within the inner radius of the fluid retaining region 610. The inner radius of the fluid retaining region 610 can define the bore region 605. It will be appreciated by a person skilled in the art that the fluid retaining region 610 may be made from non-porous material such as other polymers and the like. It will be appreciated that the fluid retaining region 610 may be manufactured from alternative processes such a winding process. The fluid retaining region 610 may correspond to the fluid retaining layer 110 in unbonded RTP body. In some embodiments the fluid retaining region may be referred to as a first pipe body region.

There is also a thermoplastic pipe region 620 of consolidated RTP body 600. The thermoplastic pipe region 620 may also be referred to as a reinforcement region. The reinforcement region may provide additional rigidity or structural reinforcement to RTP body. For example, additional reinforcement to tensile forces, pressure or torsional forces or the like may be provided. The thermoplastic pipe region 620 contains a bonded polymer matrix 625 and reinforcement fibres 626. The bonded polymer matrix in FIG. 6 is made from HDPE. The reinforcement fibres are steel wires. It will be appreciated that in other embodiments, other electrically conductive materials, ferromagnetic materials, magnetically permeable materials, or the like may be used instead of the steel wires. The steel wires are wrapped helically around the fluid retaining region 610 surrounded by a body of HDPE. The steel wires are wrapped in pairs with a lay angle of +/−55°. In other words, the first steel wire is wrapped in the clockwise direction and the further steel wire is wrapped in the counter-clockwise direction around the first steel wire. It will be appreciated that in other embodiments there may be a different number of pairs of steel wire. For example, in an embodiment, there may be two pairs of steel wire. The thermoplastic pipe region 620 may correspond to the thermoplastic reinforcement layer 120 in unbonded RTP body. The thermoplastic pipe region 620 may be referred to as the first pipe body region or a further pipe body region.

Consolidated RTP body 600 also has an outer sheath region 630. The outer sheath region 630 forms a non-porous protective outer surface of consolidated RTP body 600. The outer sheath region 630 is made from HDPE. The outer sheath region 630 is an extruded tube shape. It will be appreciated that in other embodiments the outer sheath region 630 is made from a different polymer. It will be appreciated that the outer sheath region 630 may be manufactured using alternative methods of manufacturing. The outer sheath region 630 may correspond to the outer sheath 130 in unbonded RTP body. The outer sheath region 630 may be referred to as the further pipe body region.

In another embodiment, the thermoplastic pipe region 620 may be replaced with at least one steel wire 626. In other words, in another embodiment, the consolidated RTP body 600 may include the fluid retaining region 610, one pair of steel wires 626, and the outer sheath region 630. It will be appreciated that in another embodiment there may be more than one pair of steel wires 626.

Consolidated RTP body 600 is made from a plurality of layers that have been bonded together to form one structure. There are bonding regions 640 at the boundary between the previous layers of RTP body. In the bonding region 640, the fluid retaining region 610 is welded to the thermoplastic pipe region 620. In the bonding region 640, the outer sheath region 630 can be welded to the thermoplastic pipe region 620. It will be appreciated that in some embodiments, there may be only one bonding region, for example, between the fluid retaining region 610 and thermoplastic pipe region 620 or between the outer sheath region 630 and thermoplastic pipe region 620. Consequently, there are no longer separate and free-moving layers in consolidated RTP body 600.

It will be appreciated that in some embodiments, unconsolidated RTP body includes the fluid retaining layer and the outer sheath, which are consolidated to form one structure of the fluid retaining pipe region and the outer sheath region. It will be appreciated that in some embodiments unconsolidated RTP body includes the fluid retaining layer, the thermoplastic reinforcement layer and the outer sheath, of which any two or all three of the layers may be consolidated to form one structure. In other words, in some embodiments, consolidated RTP body is one structure in which the fluid retaining region, thermoplastic reinforcement region, and the outer sheath are all bonded together. In another embodiment, the fluid retaining region and the thermoplastic reinforcement region are bonded together whilst the outer sheath remains unbonded. Conversely, in another embodiment, the outer sheath region and the thermoplastic reinforcement region are bonded together whilst the fluid retaining region remains unbonded.

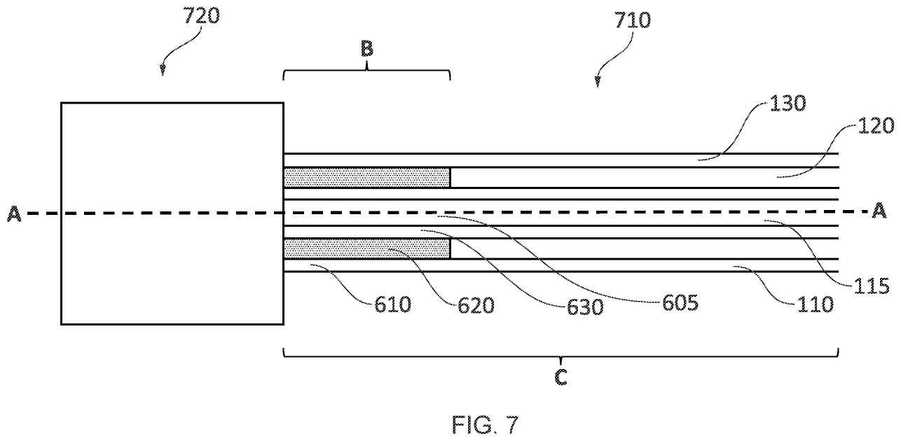

FIG. 7 illustrates an axial section of RTP body 710 and an end fitting 720. In FIG. 7, RTP body is partially consolidated. The central axis A-A of RTP body is shown in horizontal orientation. The fluid retaining layer 110, reinforcement layer 120, and outer sheath 130 are shown. It will be appreciated that in other embodiments RTP body may have the fluid retaining layer 110, at least one steel wire 410, and the outer sheath 130. During the consolidation stage, steel wires in the reinforcement layer 120 are heated by Joule heating. The Joule heating involves induction heating. It will be appreciated that in other embodiments, alternative forms of Joule heating may be used to heat the steel wires 410 in the reinforcement layer 120. It will be appreciated that Joule heating may be referred to as resistive heating. The steel wires in the reinforcement layer 120 are heated such that the polymer surrounding the steel wires in the reinforcement layer 120 melt. Furthermore, the fluid retaining layer 110 and outer sheath 130 melt. It will be appreciated that in other embodiments, only one of the fluid retaining layer 110 and the outer sheath 130 may melt. At this point the steel wires in the reinforcement layer 120 will cease to be heated by Joule heating and the melted layers will solidify and bond into one consolidated structure.

In FIG. 7, and according to certain embodiments which will be illustrated in FIGS. 8 and 9, it is possible to partially consolidate RTP body by heating a portion of the whole length C of RTP body. In FIG. 7, a partial length B of RTP body located near the end fitting is consolidated. In the partial length B is the fluid retaining region 610, the thermoplastic reinforcement region 620 and the outer sheath region 630. The remaining portion of whole length C includes the fluid retaining layer 110, the reinforcement layer 120, and the outer sheath 130. It will be appreciated that in some embodiments of partially-consolidated RTP body, there may be a different combination of layers that are consolidated to form regions that are bonded together.

FIG. 8 illustrates a method of manufacturing bonded RTP body from unbonded RTP body, also referred to as pre-consolidated RTP body. In FIG. 8, an inductive heater 800 traverses along unbonded RTP body 805 to produce consolidated RTP body 806.

The inductive heater 800 includes two electrical cables 810 for carrying an alternating current from a control unit (not shown). It will be appreciated that in some embodiments a different number of electrical cables 810 may be used. The control unit has an ammeter for measuring current through the electrical cables 810. The control unit has a voltmeter for measuring a potential difference across the electrical cables 810. The control unit has an oscillator for controlling frequency of oscillation of alternating current. The current in the electrical cables 810 passes through an activation coil 820. The coil 820 is toroidal in shape. An inner diameter of the coil 820 is greater than the diameter of unbonded RTP body. The coil 820 is composed of a hollow tubular loop 822. The coil in FIG. 8 has one loop 822. It will be appreciated that in other embodiments, the coil 820 may have a different number of loops 822. The number of loops 822 may affect the performance of the induction heater 800. The loop 822 is made from copper. It will be appreciated that in other embodiments another material may be used to make the loops of the coil, for example a material with high magnetic permeability, low electrical resistance, or the like. The coil 820 is water-cooled. That is to say water passes through the loop 822 of the coil 820. It will be appreciated that non water-cooled coils could be used. Thermocouples 830 are placed on the surface of RTP body. The thermocouples 830 measure the temperature of the outer sheath of RTP body. In some embodiments, thermocouples may be placed on the steel wires in the reinforcement layer (not shown) of RTP body. In some embodiments infra-red (IR) cameras may be used to monitor temperature of surface of RTP body and infer the temperature of the reinforcement layer.

The induction heater 800 produces a changing magnetic field. The changing magnetic field is produced as a result of current flowing through the coil 820. As acknowledged in FIG. 4, the first parameter of induction heating is frequency of oscillation of alternating current through the electrical cables 810 and coil 820. The first parameter affects the instantaneous magnitude and direction of the changing magnetic field. The frequency of oscillation of the alternating current is sinusoidal, 30 kHz-100 kHz. Consequently, the frequency of oscillation of the magnetic field is 30 kHz-100 kHz. The frequency used may be used to direct the excitation energy to the desired depth in the conductive material in the RTP body. The higher the frequency of oscillation, the shallower the depth of the current density in the conductive material, as will be discussed later. It will be appreciated that in other embodiments, a frequency of oscillation of the magnetic field outside this range may be used. It will be appreciated that in other embodiments, the sinusoidal wave may be square, triangular, sawtooth, or the like. The second parameter of induction heating is the power level. The power level relates to the electrical power passed through the activation coil 820. The power level used in the induction heater 800 is 1-10 kW. It will be appreciated that in other embodiments, a different power level may be used.

During the induction heating process, the coil 820 passes around unbonded RTP body 805 from a start position (START) of RTP body along a linear path T-T to an end position (FINISH) of RTP body. The coil traverses along T-T at a predetermined travel rate once. The travel rate in FIG. 8 is 24 inches (609.6 mm) per minute. It will be appreciated that in other embodiments the travel rate may be different. The travel rate is a third parameter of the induction heating process 800. The coil 820 is energised by current passing through the electrical cables 810 whilst at START. The coil is de-energised at an intermediate position 840 along RTP body by reducing current passing through the electrical cables 810 to zero. In some embodiments, current passing through the electrical cables may be reduced without reaching zero at the intermediate position 840. A distance between the intermediate position and FINISH is 30 mm in the present embodiment. It will be appreciated that in other embodiments the distance between the intermediate position and FINISH may be different. In some embodiments, the start position (START) may correspond to an end of RTP body. In some embodiments, the finish position (FINISH) may correspond to a position a given distance (partial length B) from the end along the RTP body. Alternatively the finish position (FINISH) may correspond to a remaining end of RTP body. It will be appreciated that in alternative embodiments the coil 820 may traverse along the linear path T-T more than once. In other words, in some embodiments, the coil 820 may repeat the traverse. In some embodiments, when the coil 820 travel along T-T is repeated the coil 820 may be de-energised at the intermediate position 840.

As the energized activation coil 820 traverses along RTP body, the changing magnetic field of the coil induces alternating current in materials of RTP body. The magnitude of alternating current in RTP body is greatest in materials with highest permeability and lowest resistance. In RTP body, the induced alternating current has a greatest amplitude in the steel wires in the reinforcement layer 120. The magnetic field produced by the coil 820 creates eddy currents in the steel wires in the reinforcement layer 120. The magnitude of current through a unit surface may be referred to as a current density. The depth of induced eddy currents from the surface of the steel wires is affected by the frequency of oscillation of the magnetic field produced by the coil 820. That is to say the first parameter of induction heating affects a so-called skin depth of eddy currents in the steel wire. The skin depth here refers to a depth from the surface of steel wire where current density has diminished to 1/e of current density at the surface of said steel wire. It will be appreciated that other variables such as the steel wire used affects the skin-depth of eddy currents. Typically at a higher frequency of oscillation, eddy currents are induced closer to the surface of steel wires. In other words, increasing the frequency of oscillation of the magnetic field produced by the coil reduces the depth, in the steel wire, at which the current density of eddy currents is below 1/e of the current density at the surface of the steel wire.

FIG. 9 illustrates another embodiment of a method of manufacturing bonded RTP body from unbonded RTP body, also referred to as pre-consolidated RTP body. In FIG. 9, unbonded RTP body 905 is moved in increments along an inductive heater 900 to produce consolidated RTP body 906.

The inductive heater 900 includes an electrical cable 910 for carrying an alternating current from a control unit (not shown). The electrical cable 910 is 1 inch (25.4 mm) in diameter. It will be appreciated that in some embodiments the diameter of electrical cable 910 may be different. It will be appreciated that in some embodiments a different number of electrical cables 910 may be used. The control unit has an ammeter for measuring current through the electrical cable 910. The control unit has a voltmeter for measuring a potential difference across the electrical cable 910. The control unit has an oscillator for controlling frequency of oscillation of alternating current. The electrical cable is wrapped around a coil housing 920. The coil housing 920 is toroidal in shape. An inner diameter of the coil housing 920 is greater than the diameter of unbonded RTP body. The electrical cable 910 is wrapped nine times around the coil housing 920. In other words, there are nine loops 915 in the electrical cable 910. It will be appreciated that in other embodiments, the electrical cable 920 may have a different number of electrical cable loops 915. The number of electrical cable loops 915 may affect the performance of the induction heater 900. In some embodiments the loops 915 may be rigid pipe made from ferromagnetic material, low resistivity material, high permeability material or the like. The electrical cable 910 is air cooled. It will be appreciated that in some embodiments the electrical cable 910 may be water-cooled. Thermocouples 930 are placed on the surface of RTP body. The thermocouples 930 measure the temperature of the outer sheath of RTP body. In some embodiments, thermocouples may be placed on the steel wires in the reinforcement layer (not shown) of RTP body. In some embodiments infra-red (IR) cameras may be used to monitor temperature of surface of RTP body and infer the temperature of the reinforcement layer.

The induction heater 900 produces a changing magnetic field. The changing magnetic field is produced as a result of current flowing through the electrical cable 910. As acknowledged in FIG. 4, the first parameter of induction heating is frequency of oscillation of alternating current through the electrical cable 910. The first parameter affects the instantaneous magnitude and direction of the changing magnetic field. The frequency of oscillation of the alternating current is sinusoidal, 30 kHz-100 kHz. Consequently, the frequency of oscillation of the magnetic field is 30 kHz-100 kHz. It will be appreciated that in other embodiments, a frequency of oscillation of magnetic field outside this range may be used. It will be appreciated that in other embodiments, the sinusoidal wave may be square, triangular, sawtooth, or the like. The second parameter of induction heating is the power level. The power level relates to the electrical power passed through the electrical cable loops 920. It will be appreciated that the electrical cable loops 920 may also be referred to as an activation coil. The power level used in the induction heater 900 is 1-10 kW. It will be appreciated that in other embodiments, a different power level may be used.

During the induction heating process, unbonded RTP body 905 is moved in increments inside the electrical cable loops 915 and coil housing 920. The induction heating process may be used to consolidate a portion of unbonded RTP body 905 by placing the induction heater 900 at one end of the portion, START, such that some of the portion of RTP body to be consolidated (marked X) is enclosed by the induction heater 900. X is equal to a total width of electrical cable loops 915. X is equal to 9 inches (228.6 mm). In some embodiments, the distance X may be different. The electrical cable loops 915 are energised by passing alternating current through the electrical cable 910. The electrical cable loops 915 remain energised for a predetermined length of time. The predetermined length of time is 105 seconds. It will be appreciated that in another embodiment the predetermined length of time may be different. After said predetermined length of time the electrical cable loops 915 are de-energized by reducing current passing through the electrical cable 910 to zero. In some embodiments, current passing through the electrical cables may be reduced without reaching zero. RTP body is moved further through the induction heater 900 in a direction 940 such that there is an overlap Y between the portion of RTP body to be bonded and bonded RTP body. In other words, RTP body is moved along the induction heater 900 by a distance of X-Y. It will be appreciated that in some embodiments, the overlap Y is zero. The electrical cable loops 915 are then re-energised for the predetermined period of time as described above, before being de-energised and moved along RTP body X-Y again, repeating until reaching another end of the portion of RTP body to be bonded, FINISH. In other words, unbonded RTP body is passed from START to FINISH in fixed increments past the electrical cable loops 915, wherein said fixed increments involve energising the electrical cable loops 915, holding for the predetermined length of time, and de-energising electrical cable loops 915. Optionally rollers may be applied to the external surface of the RTP body just after the induction heating process in order to apply pressure to the viscous state thermoplastic polymer of the reinforcement material and/or the inner or outer sheaths to improve consolidation and bonding.

As the energized electrical cable 910 is moved along RTP body, the changing magnetic field of the electrical cable 910 induces alternating current in materials of RTP body. The magnitude of alternating current in RTP body is greatest in materials with highest permeability and lowest resistance. In RTP body, the induced alternating current has greatest amplitude in the steel wires in the reinforcement layer 120. The magnetic field produced by the electrical cable 910 creates eddy currents in the steel wires in the reinforcement layer 120. The magnitude of current through a unit surface may be referred to as the current density. The depth of induced eddy currents from the surface of the steel wires is affected by the frequency of oscillation of the magnetic field produced by the electrical cable 910. That is to say the first parameter of induction heating affects the skin depth of eddy currents in the steel wire. The skin depth here refers to a depth from the surface of steel wire where current density has diminished to 1/e of current density at the surface of said steel wire. It will be appreciated that other variables such as the steel wire used affects the skin-depth of eddy currents. Typically at a higher frequency of oscillation, eddy currents are induced closer to the surface of steel wires. In other words, increasing the frequency of oscillation of the magnetic field produced by the coil reduces the depth, in the steel wire, at which the current density of eddy currents is below 1/e of the current density at the surface of the steel wire.

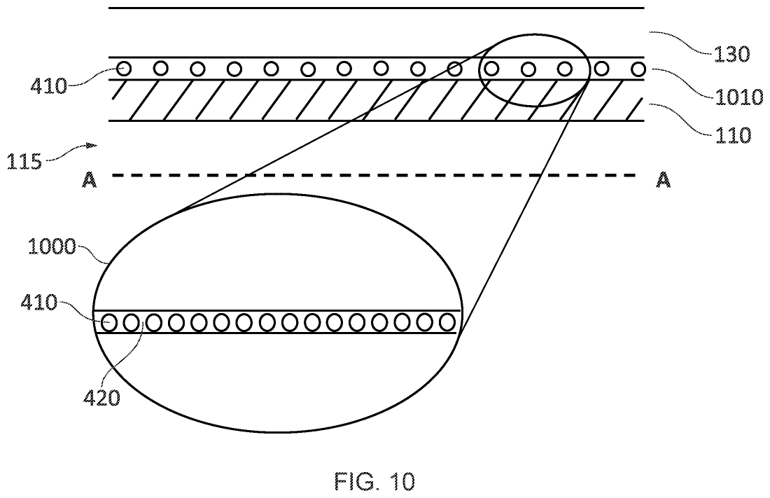

FIG. 10 illustrates an axial section of another embodiment of RTP body pre-consolidation. In FIG. 10 there is a detailed section 1000 that shows the structure of RTP body in more detail. The central axis A-A of RTP body is shown in a horizontal orientation. The multi-layer structure of RTP body is visible such that a pipe bore 115 is nearest the bottom of FIG. 10. RTP body in FIG. 10 includes the fluid retaining layer 110, a steel wire layer 1010, and the outer sheath 130. The steel wire layer 1010 contains one pair of steel wires 410. It will be appreciated that in other embodiments, the fluid retaining layer 110 may be a first pipe body layer. It will be appreciated that in some embodiments steel wire 410 may be made of a plurality of steel thread that are wrapped around one another. It will be appreciated that in other embodiments, the steel fibre may be exchanged for an alternative electrically conductive metal, polymer, carbon, ceramic, or the like, or a mixture of electrically conductive fibres and non-conductive reinforcement fibres where the electrically conductive fibres provide little or no structural reinforcement to the pipe body and purely act to facilitate consolidation of pipe layers.

In FIG. 10, the fluid retaining layer 120 forms the innermost layer of RTP body. Consequently, the fluid retaining layer 1210 defines the diameter of the bore 115 of RTP body in which bore fluid may be located. In certain embodiments, the fluid retaining layer 110 is non-porous. In certain embodiments, the fluid retaining layer 110 is made from HDPE. It will be appreciated that in other embodiments, the fluid retaining layer 110 may be made from other thermoplastics. In some embodiments, the fluid retaining layer 110 may be made from any polyethylene, a polypropylene, or a polyamide.

The steel wire layer 1010 is positioned radially between the fluid retaining layer 110 and the outer sheath 130. The pair of steel wires 410 in the steel wire layer 1010 are cross-wound helically around the layer below. In other words, the pair of steel wires 410 are wound helically around the fluid retaining layer 110. The outer sheath 130 encloses the steel wire layer 1010. In other embodiments, the steel wires 410 in the steel wire layer 1010 are frequently wound in pairs. Specifically, in the steel wire layer 1010, a first steel wire is wound in a clockwise direction and a further steel wire is wound over the first steel wire in a counter-clockwise direction. The lay angle of the helically wound steel wires 410 is +/−55°. It will be appreciated that in other embodiments a different lay angle may be used when winding steel wires 410 in the steel wire layer 1010. It will be appreciated that in other embodiments a different number of pairs of steel wire 410 may be used in the steel wire layer 1010. A gap 1020 is present between windings of the steel wires 410 in the steel wire layer 1010 and the fluid retaining layer 110 The gap 1020 is present between windings of the steel wires 410 in the steel wire layer 1010 and the outer sheath 130. In other embodiments, the gap 1020 may be a different size or there may be no gap.

The outer sheath 130 forms the outermost layer of RTP body. The outer sheath is in contact with external environment, which may involve high pressures, high temperatures, low temperatures, corrosive chemicals, or the like. The outer sheath 130 is made from HDPE that is extruded into a tubular shape. In other embodiments, the outer sheath 130 may be made using a different manufacturing process. In other embodiments, the outer sheath 130 may be made from a polyethylene, a polypropylene, or a polyamide. In some embodiments, the fluid retaining layer 110 may be a first pipe body layer. In some embodiments, the steel wires 410 may be wire elements. In some embodiments, the steel wire layer 1010 may have a different number of steel wires 410. It will be appreciated that in some embodiments, the outer sheath 130 may be a further pipe body layer.

During consolidation, unbonded RTP body in FIG. 10 is heated such that the steel wire layer 1010 is able to melt the surrounding fluid retaining layer 110 and the outer sheath 130. Consequently, the fluid retaining layer 110 bonds to the steel wire layer 1010. Also, the fluid retaining layer 110 bonds to the outer sheath 130. Also, the outer sheath 130 bonds to the steel wire layer 1010. In other words the steel wires 410 bond to the fluid retaining layer. After consolidation, the RTP body in FIG. 10 is a single structure.

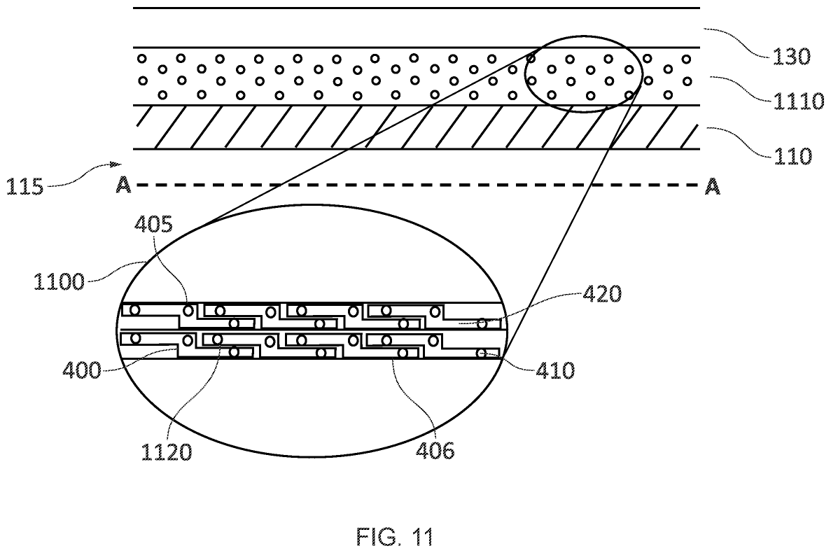

In another embodiment shown in FIG. 11, there is a detailed section 1100 that shows the structure of RTP body in more detail. FIG. 11 includes the fluid retaining layer 110, a double reinforcement layer 1110, and the outer sheath 130. The fluid retaining layer 110 is the innermost layer of RTP body. The fluid retaining layer 110 is non-porous and made using an extrusion process from HDPE. It will be appreciated that in other embodiments, the fluid retaining layer 110 may be made from another polymer. In some embodiments, the fluid retaining layer 110 may be made from any polyethylene, a polypropylene, or a polyamide. It will be appreciated that in other embodiments another manufacturing process may be used to form the fluid retaining layer 110. It will be appreciated that in some embodiments the double reinforcement layer 1110 may be referred to as the reinforcement layer 120.

The double reinforcement layer 1110 is located between the fluid retaining layer 110 and the outer sheath 130. The double reinforcement layer 1110 is composed of two pairs of tapes 400 that are wound helically around the layer below. In other words, there are four tapes 400 in the double reinforcement layer 1110. Half of the tapes 400 in the double reinforcement layer 1110 are wound helically with a clockwise lay angle of 55°. Remaining tapes 400 in the double reinforcement layer 1110 are wound helically with a counter-clockwise lay angle of 55°. There are areas of overlap 1120 where the top surface 405 of tape 400 is in contact with the bottom surface 406 of tape 400. It will be appreciated that in other embodiments a different lay angle may be used when winding tape 400 in the reinforcement layer. It will be appreciated that in other embodiments a different number of pairs of tape 400 may be used in the reinforcement layer. It will be appreciated that in some embodiments there may be no areas of overlap 1120. In other words, in some embodiments, the tapes will be arranged such that they sit end to end. The tapes 400 are made from steel wires 410 surrounded by HDPE 420. In some embodiments the steel wires 410 may be bonded to the HDPE 420. The tapes 400 may be the tapes in FIG. 4. It will be appreciated that the in other embodiments the steel wire 410 of the tape 400 may be made of alternative electrically conductive materials, ferromagnetic materials, magnetically permeable materials, or the like. It will be appreciated that in other embodiments, the steel fibre may be exchanged for an alternative electrically conductive metal, polymer, carbon, ceramic, or the like, or a mixture of electrically conductive fibres and non-conductive reinforcement fibres where the electrically conductive fibres provide little or no structural reinforcement to the pipe body and purely act to facilitate consolidation of pipe layers. It will be appreciated that in other embodiments the HDPE 420 may be replaced by alternative polymers.

The outer sheath 130 forms the outermost layer of RTP body. The outer sheath is in contact with external environment, which may be offshore or onshore. The external environment may involve high pressures, high temperatures, low temperatures, corrosive chemicals, or the like. The outer sheath 130 is made from HDPE that is extruded into a tubular shape. In other embodiments, the outer sheath 130 may be made using a different manufacturing process. In other embodiments, the outer sheath 130 may be made from a different polymer. It will be appreciated that in some embodiments, the outer sheath 130 may be made from any polyethylene, a polypropylene, or a polyamide. In some embodiments, the fluid retaining layer 110 may be a first pipe body layer.

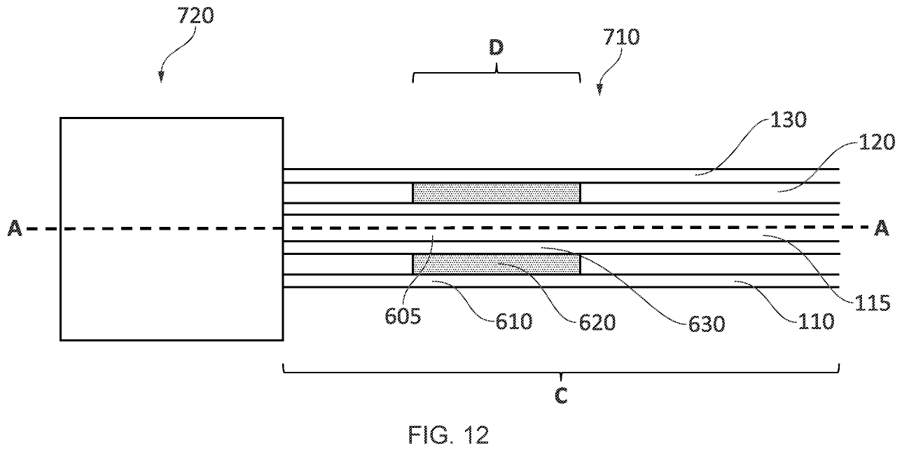

FIG. 12 illustrates another embodiment of the present disclosure. FIG. 12 illustrates an axial section of RTP body 710 and the end fitting 720. RTP body 710 is partially consolidated in FIG. 12. The central axis A-A of RTP body is shown in a horizontal orientation. The fluid retaining layer 110, reinforcement layer 120, and outer sheath 130 are shown. It will be appreciated that in other embodiments RTP body may have the fluid retaining layer 110, at least one steel wire 410, and the outer sheath 130. It will be appreciated that in some embodiments the at least one steel wire 410 may be exchanged for an alternative electrically conductive metal wire, polymer wire, carbon wire, ceramic wire, or the like, or a mixture of electrically conductive fibres and non-conductive reinforcement fibres where the electrically conductive fibres provide little or no structural reinforcement to the pipe body and purely act to facilitate consolidation of pipe layers. During the consolidation stage, steel wires in the reinforcement layer 120 are heated by Joule heating. The Joule heating involves induction heating. It will be appreciated that in other embodiments, alternative forms of Joule heating may be used to heat the steel wires 410 in the reinforcement layer 120. The steel wires in the reinforcement layer 120 are heated such that the polymer surrounding the steel wires in the reinforcement layer 120 melt. Furthermore, the fluid retaining layer 110 and outer sheath 130 melt. It will be appreciated that in other embodiments, only one of the fluid retaining layer 110 and the outer sheath 130 may melt. At this point the steel wires in the reinforcement layer 120 will cease to be heated by Joule heating and the melted layers will solidify and bond into one consolidated structure.

In FIG. 12, and according to certain embodiments illustrated in FIGS. 8 and 9, it is possible to partially consolidate RTP body by heating a portion of the whole length C of RTP body. In FIG. 12, a partial length D of RTP body located away from the end fitting is consolidated. In other words, the fluid retaining region 610, the thermoplastic reinforcement region 620, and the outer sheath region 630 are consolidated into one structure. In the remaining length not included in partial length D, RTP body is unbonded and includes the fluid retaining layer 110, the reinforcement layer 120 and the outer sheath 130.

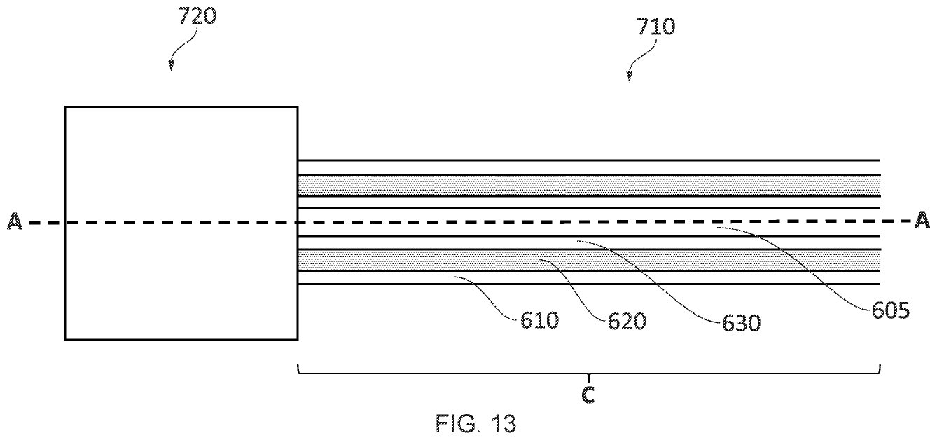

According to another embodiment illustrated in FIG. 13, the whole length C of RTP body in consolidated. The RTP body is consolidated using induction heating described in FIG. 9. It will be appreciated that in another embodiment, RTP body may be consolidated by using induction heating described in FIG. 8 or by heating the reinforcement layer 120 using Joule heating. Along the entirety of RTP body in FIG. 13 is the fluid retaining region 610, the thermoplastic reinforcement region 620 and the outer sheath region 630.

The multilayer RTP related to certain embodiments may be suitable for internal pressures up to 5000 psi. Multilayer RTP may comprise MDPE, HDPE, XLPE, PE-RT, polypropylene (commercial polyolefin grades or grades with additives for temperature and chemical stability), polyamides (e.g., PA-12, PA-66, PA-6), thermoplastic elastomers, flexible polyvinyl chloride, Acrylonitrile butadiene styrene (ABS), polyphenylene sulfide (PPS), PFA, MFA, or other polymers or polymer alloys. The multilayer RTP may also comprise filled polymers where the polymer contains a portion of a filler material, such as fibres or particles.

The multilayer RTP body may comprise a multi-layer structure incorporating at least one intermediate reinforcement layer to withstand internal pressure and/or tension in the pipe when in use. Such reinforcement layers may comprise spirally wound reinforcement tapes, comprising at least one polymer layer reinforced with filaments of any or a combination of glass, carbon, basalt, aramid, tensilised polyester or metal fibres or wires. In this case the reinforcements may be substantially aligned in the longitudinal direction of the tape and embedded within, or adhered to, or sandwiched between, the at least one polymer layer. A reinforcement tape may also comprise warp and weft fibres of similar or different materials or sizes so that the longitudinally aligned fibres/bundles/strands are bound or fixed in position with respect to one another in a woven fibre tape. The reinforcements may comprise long discrete fibres, or may be bundled, or twisted together as strands. Alternatively, reinforcement fibres may be braided around the pipe, or bundles of fibres may be constrained within a braided element, the braided elements being spirally wound or braided around the inner polymer barrier layer of the pipe as reinforcements. Fibres and/or strands or braids of fibres may be wound around the pipe in a helical manner, with lay angles optimised for pipe performance (the higher the angle the greater the pressure retainment capability, the lower the angle the greater the tension capability) or interwoven into a braid around the pipe. Layers of reinforcements may be applied sequentially at different angles to optimise and torsionally balance the structure in manufacture and use.

Throughout the description and claims of this specification, the words “comprise” and “contain” and variations of them mean “including but not limited to” and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of the features and/or steps are mutually exclusive. The invention is not restricted to any details of any foregoing embodiments. The invention extends to any novel one, or novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

While certain arrangements of the inventions have been described, these arrangements have been presented by way of example only, and are not intended to limit the scope of the disclosure. Indeed, the novel methods and systems described herein may be embodied in a variety of other forms. Furthermore, various omissions, substitutions and changes in the systems and methods described herein may be made without departing from the spirit of the disclosure. The accompanying claims and their equivalents are intended to cover such forms or modifications as would fall within the scope and spirit of the disclosure. Accordingly, the scope of the present inventions is defined only by reference to the appended claims.

Features, materials, characteristics, or groups described in conjunction with a particular aspect, arrangement, or example are to be understood to be applicable to any other aspect, arrangement or example described in this section or elsewhere in this specification unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The protection is not restricted to the details of any foregoing arrangements. The protection extends to any novel one, or any novel combination, of the features disclosed in this specification (including any accompanying claims, abstract and drawings), or to any novel one, or any novel combination, of the steps of any method or process so disclosed.

Furthermore, certain features that are described in this disclosure in the context of separate implementations can also be implemented in combination in a single implementation. Conversely, various features that are described in the context of a single implementation can also be implemented in multiple implementations separately or in any suitable subcombination. Moreover, although features may be described above as acting in certain combinations, one or more features from a claimed combination can, in some cases, be excised from the combination, and the combination may be claimed as a subcombination or variation of a subcombination.

Moreover, while operations may be depicted in the drawings or described in the specification in a particular order, such operations need not be performed in the particular order shown or in sequential order, or that all operations be performed, to achieve desirable results. Other operations that are not depicted or described can be incorporated in the example methods and processes. For example, one or more additional operations can be performed before, after, simultaneously, or between any of the described operations. Further, the operations may be rearranged or reordered in other implementations. Those skilled in the art will appreciate that in some arrangements, the actual steps taken in the processes illustrated and/or disclosed may differ from those shown in the figures. Depending on the arrangement, certain of the steps described above may be removed, others may be added. Furthermore, the features and attributes of the specific arrangements disclosed above may be combined in different ways to form additional arrangements, all of which fall within the scope of the present disclosure. Also, the separation of various system components in the implementations described above should not be understood as requiring such separation in all implementations, and it should be understood that the described components and systems can generally be integrated together in a single product or packaged into multiple products.

For purposes of this disclosure, certain aspects, advantages, and novel features are described herein. Not necessarily all such advantages may be achieved in accordance with any particular arrangement. Thus, for example, those skilled in the art will recognize that the disclosure may be embodied or carried out in a manner that achieves one advantage or a group of advantages as taught herein without necessarily achieving other advantages as may be taught or suggested herein.

Conditional language, such as “can,” “could,” “might,” or “may,” unless specifically stated otherwise, or otherwise understood within the context as used, is generally intended to convey that certain arrangements include, while other arrangements do not include, certain features, elements, and/or steps. Thus, such conditional language is not generally intended to imply that features, elements, and/or steps are in any way required for one or more arrangements or that one or more arrangements necessarily include logic for deciding, with or without user input or prompting, whether these features, elements, and/or steps are included or are to be performed in any particular arrangement.

Conjunctive language such as the phrase “at least one of X, Y, and Z,” unless specifically stated otherwise, is otherwise understood with the context as used in general to convey that an item, term, etc. may be either X, Y, or Z. Thus, such conjunctive language is not generally intended to imply that certain arrangements require the presence of at least one of X, at least one of Y, and at least one of Z.

Language of degree used herein, such as the terms “approximately,” “about,” “generally,” and “substantially” as used herein represent a value, amount, or characteristic close to the stated value, amount, or characteristic that still performs a desired function or achieves a desired result. For example, the terms “approximately”, “about”, “generally,” and “substantially” may be used to refer to an amount that is within less than 10% of the stated amount. As another example, in certain arrangements, the terms “generally parallel” and “substantially parallel” refer to a value, amount, or characteristic that departs from exactly parallel by less than or equal to 15°, 10°, 5°, 3°, 1 degree, or 0.1 degree. The ranges disclosed herein also encompass any and all overlap, sub-ranges, and combinations thereof, and any specific values within those ranges. Language such as “up to,” “at least,” “greater than,” “less than,” “between,” and the like includes the number recited. Numbers and values used herein preceded by a term such as “about” or “approximately” include the recited numbers. For example, “approximately 7 mm” includes “7 mm” and numbers and ranges preceded by a term such as “about” or “approximately” should be interpreted as disclosing numbers and ranges with or without such a term in front of the number or value such that this application supports claiming the numbers, values and ranges disclosed in the specification and/or claims with or without the term such as “about” or “approximately” before such numbers, values or ranges such, for example, that “approximately two times to approximately five times” also includes the disclosure of the range of “two times to five times.” The scope of the present disclosure is not intended to be limited by the specific disclosures of preferred arrangements in this section or elsewhere in this specification, and may be defined by claims as presented in this section or elsewhere in this specification or as presented in the future. The language of the claims is to be interpreted broadly based on the language employed in the claims and not limited to the examples described in the present specification or during the prosecution of the application, which examples are to be construed as non-exclusive.

What is claimed is:

1. A method of providing RTP body for storage and/or transportation of a fluid, comprising:
providing a first pipe body layer;
providing a further pipe body layer coaxial with the first pipe body layer;
providing a plurality of helically wound wire elements disposed between the first pipe body layer and the further pipe body layer;
heating surrounding precursor thermoplastic material via Joule heating of the wire elements thereby providing viscous state thermoplastic polymer at least one of a first interface location between the first pipe body layer and the further pipe body layer; and
subsequently cooling the viscous state thermoplastic polymer for joint consolidation thereby consolidating RTP body over at least a portion of a whole length of the RTP body.

2. The method as claimed in claim 1, further comprising:
said step of heating via Joule heating comprises, via an electromagnetic coil that comprises at least one turn, and optionally comprises a single turn coil or a multi turn coil, generating a magnetic field thereby inducing eddy currents in the ferromagnetic material wire elements thereby heating a surrounding volume via Joule heating.

3. The method as claimed in claim 1, further comprising:
applying pressure to a joint region where precursor thermoplastic material abuts with an adjacent layer until a viscous state thermoplastic polymer solidifies and optionally consolidating the RTP body over said a portion by bonding a first pipe body region associated with the first pipe body layer with a further pipe body region associated with the further pipe body layer.

4. The method as claimed in claim 1, further comprising:
during said step of heating the precursor thermoplastic material, determining a temperature of the thermoplastic material continuously or at least repeatedly via an infra-red camera directed at a surface proximate to an expected heating position and/or one or more thermocouples.

5. The method as claimed in claim 1 whereby heating via Joule heating comprises:
via an electromagnetic coil that comprises a single turn, urging the coil in an energised state from a start position proximate to a first end of the further pipe body layer towards a finish position a predetermined distance from the start position to thereby complete a traverse over a section of the further pipe body layer corresponding to said a position; and
repeating the traverse a plurality of times and on each traverse de-energising the coil at least 3 centimetres before the respective finish position; and optionally
applying an external consolidation force to the external surface of the RTP body, via rollers, to improve the movement and consolidation of viscous state thermoplastic polymer.

6. The method as claimed in claim 5, further comprising:
Energising the coil with a power range of from 4 kW to 8 kW via a 15 kW water cooled induction unit at a frequency of from 60 kHz to 80 KHz.

7. The method as claimed in claim 5, further comprising:
ensuring there is no dwell time at power as the coil is initially energised or de-energised.

8. The method as claimed in claim 1 whereby heating via Joule heating comprises:
via a multi turn electromagnetic coil, that optionally includes from 7 turns to 11 turns, selectively urging precursor pipe body comprising the first pipe body layer and the further pipe body layer through a cylindrical jig around which the coil is wrapped, in stages step-by-step and selectively energising the coil only with movement of the precursor pipe body paused and without overlapping a footprint of the coil on any region of precursor pipe body whilst heating; and optionally applying an external consolidation force to the external surface of the RTP body, via rollers, to improve the movement and consolidation of viscous state thermoplastic polymer.

9. The method as claimed in claim 8, further comprising:
applying from 5% to 15% of a total delivered power at from 2.8 kW to 3.5 kW.

10. The method as claimed in claim 8, further comprising:
energising the coil at a maximum frequency of from 28 kHz to 35 kHz.

11. The method as claimed in claim 8, further comprising:
pausing movement of the precursor pipe body and energising the coil whilst in a paused state thereby heating a respective section of the precursor pipe body for from 95 seconds to 115 seconds.

12. The method as claimed in claim 8, further comprising:
Joule heating from 70 centimetres to 90 centimetres in length of a total length of the precursor pipe body.

13. RTP body for storage and/or transportation of a fluid, comprising:
a first pipe body region;
a further pipe body region coaxial with the first pipe body region; and
a plurality of wire elements that extend helically along at least a portion of a whole length of the first pipe body region and that are embedded, along said a portion, in thermoplastic material that has a crystal structure associated with a cooling temperature gradient that is cooler at a radially outer region than at a radially inner region relative to a central bore axis; wherein
RTP body comprising the first and further pipe body region is consolidated along said a portion.

14. The RTP body as claimed in claim 13, further comprising:
the crystal structure is a crystal structure associated with a rate of cooling associated with convection cooling from a metal-thermoplastic interface.

15. The RTP body as claimed in claim 13, further comprising:
the thermoplastic material is a polyethylene or a polypropylene or a polyamide and the consolidated region has a from 60% to 90% crystallinity and optionally the consolidated region has an amorphous volume of from 10% to 40% of amorphous material.

16. The RTP body as claimed in claim 13, further comprising:
the first pipe body region comprises a one of a fluid retaining pipe region or an outer sheath pipe region and the further pipe body region comprises a thermoplastic pipe region or a remainder one of the fluid retaining pipe region and the outer sheath region.

17. An RTP for storage and/or transportation of a fluid, comprising:
a first end fitting that terminates a first end of a segment of the RTP body and a further end fitting that terminates a remaining end of the RTP body; wherein
the RTP body comprises a thermoplastic pipe region that comprises a plurality of embedded wire elements that extend helically within the thermoplastic pipe region over a portion of the RTP body that extends from the first end fitting where the RTP body is consolidated or that extends over a portion of the RTP body between the first end fitting and the further end fitting where the RTP body is consolidated.

18. The RTP as claimed in claim 17, further comprising:
said a portion comprises a length of from 0.5 m to 2.0 m from the first end fitting and the wire elements and thermoplastic pipe region terminate at an end position of said a length.

19. The RTP as claimed in claim 17, further comprising:
said a portion comprises a whole length of the RTP body between the first and further end fittings and the thermoplastic pipe region and associated embedded wire elements extend along the whole length.

20. The RTP as claimed in claim 17, further comprising:
the wire elements each comprise a single strand metal wire or single strand metal alloy wire or a multi strand metal wire or a multi strand metal alloy wire and optionally a first plurality of the wires are disposed a respective first radial distance from a main central axis associated with the RTP and a further plurality of wires are disposed a respective further radial distance, that is greater than the first radial distance from the main central axis.
